(19) United States
(12) Patent Application Publication
(10) Pub. No.: US 2015/0078433 A1
(43) Pub. Date: Mar. 19, 2015

(54) REDUCING BANDWIDTH AND/OR STORAGE OF VIDEO BITSTREAMS

(71) Applicant: Broadcom Corporation, Irvine, CA (US)

(72) Inventor: Larry Pearlstein, Newtown, PA (US)

(73) Assignee: Broadcom Corporation, Irvine, CA (US)

(21) Appl. No.: 14/041,574

(22) Filed: Sep. 30, 2013

Related U.S. Application Data
(60) Provisional application No. 61/879,527, filed on Sep. 18, 2013.

(51) Int. Cl. H04N 19/172

(52) U.S. Cl. CPC H04N 19/00266
USPC 375/240.02

(57) ABSTRACT

Bandwidth, power and/or storage may be saved when certain pictures of a video bitstream are selectively reduced in size prior to transmission and/or storage in a video decoding process. Any number of criteria may be used in determining which pictures are to be selected for reduction. For example, pictures that are to be used for display only and not to be used for future picture predictions or may be used only in a small number future picture predictions may be reduced.

### CROSS-REFERENCE TO RELATED APPLICATIONS

This application claims priority to U.S. Provisional Patent Application No. 61/879,527, filed Sep. 18, 2013, and entitled “Reducing Bandwidth and/or Storage Of Video Bitstreams,” the entirety of which is incorporated by reference herein.

### BACKGROUND

1. Technical Field

The subject matter described herein relates to video encoders and decoders and reducing bandwidth and/or storage of video data streams during the encoding and decoding process.

2. Description of Related Art

Digital video has become increasingly important in many consumer electronic applications, including video compact disc (VCD), digital video disc (DVD), videophone, portable media player, video conferencing devices, video recording devices, and electronic-learning tools, etc. Video compression is essential in providing solutions of high quality (e.g., high resolution, low distortion) at low costs (low bit rate for storage or transmission).

Various video coding standards exist for recording, compressing, and distributing high definition (HD) video. For instance, the H.264/MPEG-4 Part 10 or Advanced Video Coding (AVC) standard is currently one of the most commonly used formats for many video applications, including broadcast of HD television signals, video content acquisition and editing systems, camcorders, security applications, Internet and mobile network video, Blu-ray Disc™, and real-time conversational applications such as video chat and video conferencing systems. However, as services become more diversified and as HD video (e.g., 2 k by 1 k resolution) and beyond-HD formats (e.g., 4 k by 2 k or 8 k by 4 k resolution) grow in popularity, increased coding efficiency may be desired.

The H.265/MPEG-H Part 2 or High Efficiency Video Coding (HEVC) standard has been created to address existing applications of H.265/MPEG-4 AVC with improved compression performance. The HEVC standard achieves improvement in compression efficiency in relation to prior video coding standards through several smaller improvements in its design.

### BRIEF SUMMARY

Methods, systems, and apparatus are described for video encoders and decoders that process video data streams to reduce picture precision, substantially as shown in and/or described herein in connection with at least one of the figures, and as set forth more completely in the claims.

### BRIEF DESCRIPTION OF THE DRAWINGS/FIGURES

The accompanying drawings, which are incorporated herein and form a part of the specification, illustrate the subject matter of the present application and, together with the description, further serve to explain the principles of the embodiments described herein and to enable a person skilled in the pertinent art to make and use such embodiments.

FIG. 1 shows a block diagram of an electronic device that includes a video decoder, according to an example embodiment.

FIG. 2 shows different picture types for a sequence of pictures according to the MPEG-4 standard.

FIG. 3 shows a block diagram of a video encoder, according to an example embodiment.

FIG. 4 shows a block diagram of a video decoder, according to an example embodiment.

FIG. 5 shows a block diagram of a video decoder, according to an example embodiment.

FIG. 6 shows a flowchart providing a process for selectively reducing a precision of a picture, according to an example embodiment.

FIG. 7 shows a block diagram of a pixel component truncator, according to an example embodiment.

FIG. 8 shows a flowchart providing a process of truncating a pixel component of a picture, according to an example embodiment.

FIG. 9 shows a block diagram of an electronic device that includes a bit length reducer for reducing a precision of a picture, according to an example embodiment.

FIG. 10 shows a block diagram of an example computer in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### A. Example Embodiments

### 1. Introduction

The following detailed description discloses numerous example embodiments.

The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, disclosed embodiments may be combined with each other in any manner.

### 2. Example Data Stream Embodiments

Embodiments relate to the processing of data streams, such as video data streams, to reduce transmission bandwidth and/or storage requirements for the data streams. Embodiments are described herein in terms of being applied to video for purposes of illustration, but such description is not intended to be limiting.

In the case of video data, embodiments may be applied to any type of video data. For instance, a color video signal may be represented in a YCbCr color space, which represents brightness and color information separately. In this color space, the video signal is separated into three pixel components called luma (Y) and chroma (Cb, Cr). The Y component represents brightness. The two chroma components Cb and Cr represent the extent of color deviation toward blue and red, respectively. In other words, the Cb component is related to blue minus luma and the Cr component is related to red minus luma. While other color models (e.g., RGB, etc.) may be used in embodiments, the YCbCr model presents the benefits of improved compressibility due to decorrelation of the color and more efficient data compression due to the separation of the luma component from the chroma components. The luma component is perceptually more important than the chroma components, and thus the chroma components can be represented at lower resolution to achieve more efficient data compression. The ratios of information stored for these different components may be represented in the following sampling structure Y:Cb:Cr. Because the human visual system is more sensitive to the luma component than the chroma components, the 4:2:0 sampling structure is generally used where each chroma component has one fourth of the number of samples of the luma component (i.e., half the number of samples in both the horizontal and vertical dimensions). Each sample per pixel component may be represented with any number of bits, with 8 bits of precision per pixel component being typical.

A video encoder typically receives a video signal, which may be represented with 8 bits (or other number of bits) of precision per pixel component (e.g., Y, Cb, Cr), and outputs a coded video bitstream comprising of a plurality of pictures. A video decoder may receive the coded video bit stream from the video encoder (e.g., through some medium such as a communication channel) and invert the video encoder's encoding process to generate a decoded video bitstream.

For example, a video decoder may receive the coded video bitstream and output a decoded video bitstream that includes a sequence of decoded or reconstructed pictures. Some of the decoded pictures may be needed for future predictions of subsequent pictures that are to be decoded, and some of the decoded pictures may be used only for display purposes but not for future predictions. It is becoming more popular to code pictures with a higher pixel precision (e.g., greater than 8 bits per pixel component) than needed for acceptable quality display, as higher pixel precision enables better compression, better fidelity and better quality pictures for viewers with displays that can handle higher pixel precision.

In example embodiments, bandwidth, power and/or storage may be saved when certain pictures are selectively reduced in size prior to transmission and/or storage. Any number of criteria may be used in determining which pictures are to be selected for reduction. For example, pictures that are to be used for display only and not to be used for future predictions or may be used only in a small number future predictions may be reduced in size without seriously degrading picture quality. The prediction operation is part of a video encoding or decoding process, which exploits the spatial or temporal redundancy of a video sequence to determine a prediction of a current picture. The difference between the actual/original picture and the prediction may be encoded or decoded, which requires fewer bits, rather than the whole actual picture.

### 3. Example Video Coding Embodiments

Example embodiments relate to video processing performed by video encoders and decoders. For example, embodiments include mobile devices where video processing is performed, such as a mobile phone (e.g., a smart phone), a laptop, a netbook, a tablet computer, a handheld media player, and further types of mobile devices. In another example, embodiments include stationary electronic devices where video processing is performed, such as set-top boxes, desktop computers, DVD systems, and further types of electronic devices having video, processing, recording or playing capability.

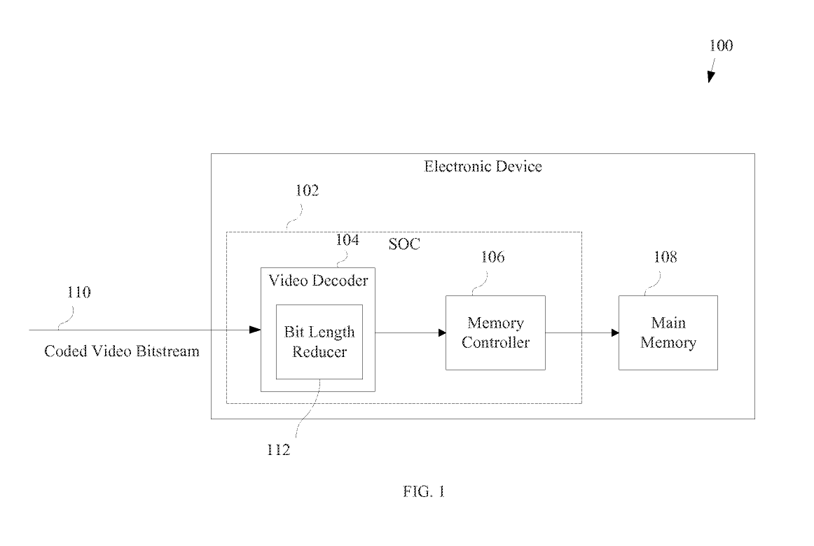

FIG. 1 shows a block diagram of an electronic device 100 with video processing capability, according to an example embodiment. Electronic device 100 may be a smart phone, a handheld computing device, a desktop computer, etc. As shown in FIG. 1, electronic device 100 includes a video decoder 104, a memory controller 106, and a main memory 108. Furthermore, video decoder 104 includes a bit length reducer 112. An SOC (system-on-chip) 102 is optionally present in electronic device 100, which is an integrated circuit chip. In an embodiment, video decoder 104 and memory controller 106 may be separate or may be included together in SOC 102 when present. The components of electronic device 100 may be mounted to or contained in a housing. The housing may further contain a circuit board for the mounting of integrated circuit chips and/or other electrical devices. The components of electronic device 100 are described as follows.

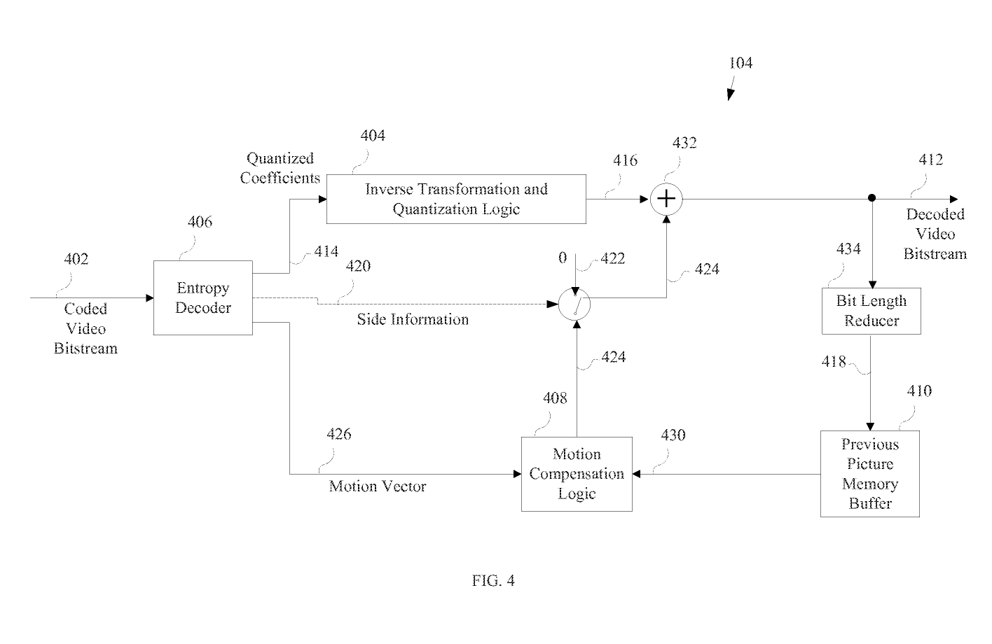

Video decoder 104 receives and decodes or decompresses coded video bitstream 110. Video decoder 104 may be a standalone commercial off-the-shelf (COTS) device or a proprietary one. In an embodiment, bit length reducer 112 is present in video decoder 104 to reduce a precision of some pictures in coded video data bitstream 110 to save bandwidth, reduce storage requirements for video data, and/or for other reasons. Video decoder 104 (and bit length reducer 112) may be implemented in hardware or a combination of hardware with software and/or with firmware (e.g., an electronic circuit, a processor such as a microprocessor, a microcontroller, etc., a digital signal processor, a computer program, etc.). A more detailed description of an example of video decoder 104 is provided below in FIG. 4. Furthermore, additional detail and example embodiments of bit length reducer 112 are described in the next section.

Memory controller 106 is a circuit that manages the flow of data going to and from main memory 108. Memory controller 106 contains logic to facilitate reads and writes to main memory 108 as well as refresh main memory 108 to prevent data loss. Memory controller 106 or its functionality may be directly integrated into SOC 102 rather than being a discrete component. Memory controller 106 may be implemented as a separate chip or as part of an integrated chip (e.g., in a microprocessor) or a combination of hardware with software and/or with firmware.

Main memory 108 is a storage area for data (e.g., decoded video bitstreams). Main memory 108 may also serve as the storage area for coded video to be decoded. Main memory 108 is shown separate from SOC 102 and in electronic device 100 in FIG. 1. However, main memory 108 may reside in any other location on electronic device 100 or in another device separate from electronic device 100. Main memory 108 may be a physical storage device, such as a memory device (e.g., static random access memory (SRAM), dynamic random access memory (DRAM), etc.), a hard disc drive, optical storage, or a virtual storage location.

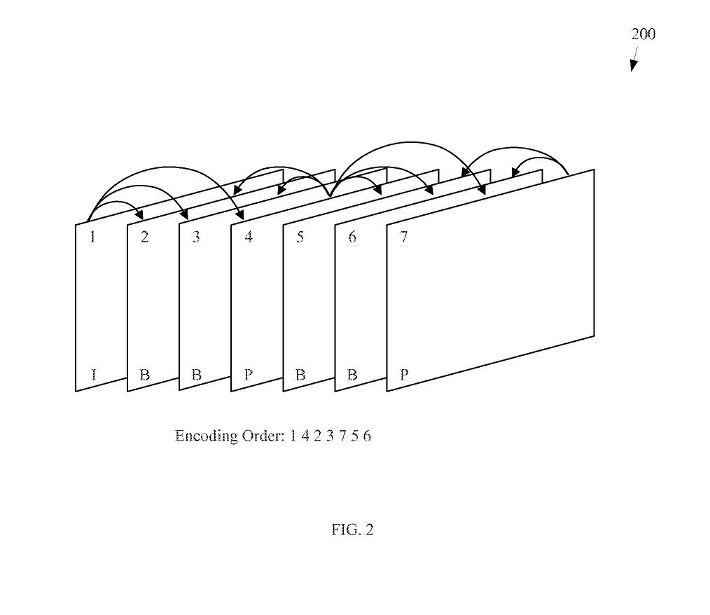

Coded video bitstream 110 may include a plurality of pictures, each having a type. The names of the picture types may vary depending on the video coding standard used. For example, in the MPEG-4 standard, the picture types include I, P, and B where as in the H.264 standard, the picture types include I, P, B, SI, and SP. The picture type of a picture may dictate the prediction mode that is used in encoding and decoding that picture. In addition, a picture may be classified as a reference or intra-picture (e.g., I-frame in MPEG-4 and instantaneous decoding refresh (IDR) picture in H.264), which is associated with an intra-picture prediction mode. In the intra-picture prediction mode, the picture that is currently being processed is coded directly. The intra-picture prediction mode is helpful if a picture contains regions that cannot be predicted well. Another picture type is an inter-picture or a predictive picture, which is associated with an inter-picture prediction mode. In the inter-picture prediction mode, the current picture is predicted from one or more pictures, and only the prediction error is specified and coded. A more specific example of picture types is shown in FIG. 2

FIG. 2 shows different picture types for a sequence of pictures 200 in a video data stream according to the MPEG-4 standard. In this standard, a coded picture comprises a picture header, optional extensions immediately following it, which is followed by picture data. The coded picture can be a coded frame or a coded field as an I-frame, a P-frame, or a B-frame. For an interlaced video signal, a “field” is the assembly of alternative lines of a frame. An interlaced frame therefore includes two fields, a top field and a bottom field. An I-frame picture or a pair of field pictures includes a first field picture as an I-picture and the second field picture as an I-picture or a P-picture. A coded B-frame is a B-frame picture or a pair of B-field pictures and a coded P-frame is a P-frame picture or a pair of P-field pictures. In the sequence of pictures shown in FIG. 2, picture 1 is an intra-coded I-frame, which is coded directly. Pictures 4 and 7 are predictive P-frames, which are predicted from a previous picture in the video data stream. Pictures 2, 3, 5 and 6 are bidirectional B-frames, each of which are predicted from a previous picture and a following picture in the video data stream. The arrows shown in FIG. 2 illustrate the interdependencies of the different picture types. For example, the three arrows from picture 1 going to pictures 2, 3, and 4 indicate that picture 1 was used to predict pictures 2, 3, and 4. The arrows from picture 4 to pictures 2, 3 indicate that picture 4 was used, in combination with picture 1, to predict pictures 2 and 3. The arrow from picture 4 to picture 7 indicate that picture 4 was used to predict picture 7. Because picture 1 was used to predict picture 4, picture 7 also indirectly depends on picture 1. Thus, any error made in encoding or decoding picture 1 may be propagated to picture 4 and picture 7. The arrows from pictures 4 and 7 to pictures 5, 6 indicate that picture 4 was used, in combination with picture 7, to predict pictures 5 and 6.

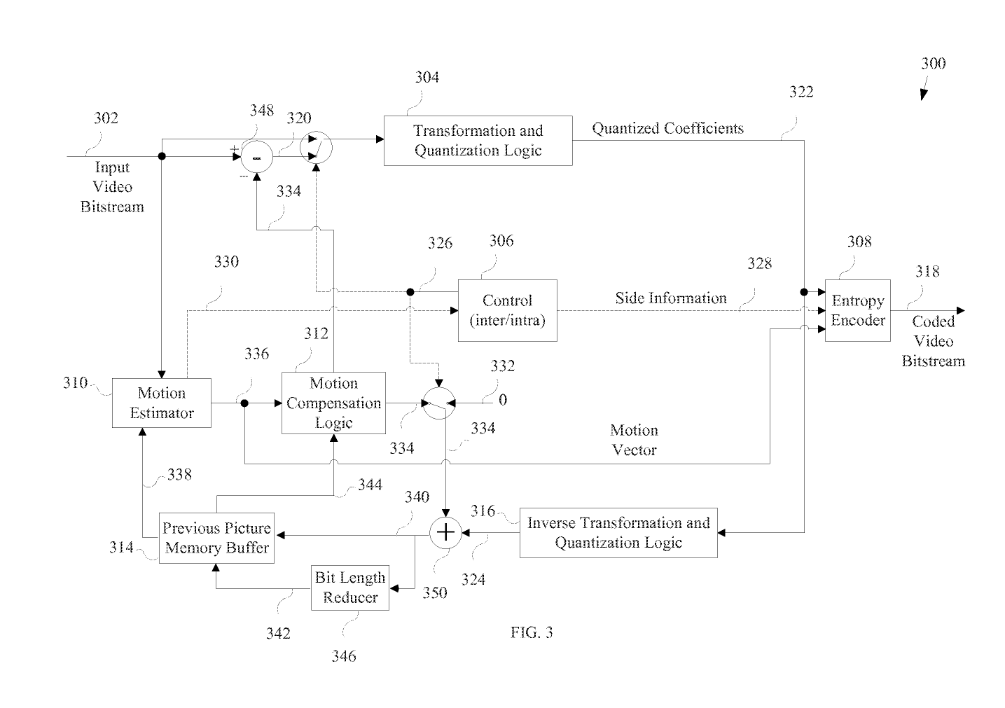

Electronic device 100 may receive coded video bitstream 110 from another device (e.g., a server, a video capture device, etc.), which may include an encoder, such as the one shown in FIG. 3. FIG. 3 shows a block diagram of a video encoder 300 that performs video compression or coding, according to an example embodiment. Video encoder 300 may include a transformation and quantization logic 304, a control logic 306, an entropy encoder 308, a motion estimator 310, a motion compensation logic 312, a previous picture memory buffer 314, an inverse transformation and quantization logic 316, a subtractor 348, and an adder 350. In an embodiment, a bit length reducer 346 may also be present in video encoder 300. Each of the components of video encoder 300 may be implemented as a combination of hardware with software and/or with firmware (e.g., an electronic circuit, an application processor, a digital signal processor, a computer program that executes in one or more processors, etc.). Video encoder 300 is shown for purposes of illustration, and is not intended to be limiting, as other types of video encoders are applicable to embodiments. For example, while video encoder 300 may be configured for encoding of MPEG-2 format video data, in other embodiments, video encoder 300 may be configured for encoding of H.264 format video data, H.265 format video data, or other format of video data.

Video encoder 300 may be implemented according to any existing or future video coding standard (e.g., MPEG-2, MPEG-4, AVC or HEVC). An encoding algorithm to produce a coded video bitstream 318 from an input video bitstream 302 may proceed by splitting each picture of input video bitstream 302 into block-shaped regions (e.g., 8×8 pixel or 16×6 pixel). It is more manageable to compress a picture in smaller blocks as the encoding algorithm complexity may be reduced, although larger blocks including the entire picture may also be used. Block-based hybrid video coding involves three stages: prediction, transformation and quantization, and entropy coding. These stages may be performed by the different components of video encoder 300 as follows.

Input video bitstream 302 includes a stream of video data that includes two-dimensional blocks of data for a plurality of pictures in the video data stream. Thus, input video bitstream 302 may be processed block-wise, and the block that is undergoing processing may be called a “current block” and the picture to which the current block belongs may be called a “current picture.” In the prediction stage, a reference block that is similar to a current block is determined so that, instead of the current block, the difference between the reference block and the current block is to be coded.

Control logic 306 receives motion data 330 from motion estimator 310. Motion data 330 includes a selected reference picture and a motion vector to be applied for predicting the samples of each block. If the current block is from an intra-picture, which may be the first picture of a video sequence or the first picture at each clean random access point into a video sequence, the intra-picture predictive mode is used. In the intra-picture predictive mode, the reference block may be calculated with mathematical functions of neighboring pixels of the current block. In other words, the intra-picture is coded using some prediction of data spatially from region-to-region within the same picture, but has no dependence on other pictures. If the current block is from an inter-picture, which may be any of the remaining pictures of a sequence or pictures between random access points, the inter-picture predictive mode is used. In the inter-picture predictive mode, the reference block may be in a picture before or after the current picture or the reference block may be a weighted function of blocks from multiple pictures. Control logic 306 outputs control signal 326 indicating whether intra or inter-picture predictive mode is to be used for the current block. Control logic 306 may provided motion data 330 to entropy encoder 308 as side information 328 to be coded and transmitted to a decoder that corresponds to video decoder 300 as part of coded video bitstream 318. Side information 328 may enable such decoder to generate an identical inter-picture prediction as video encoder 300.

In the intra-picture predictive mode, the current block in input video bitstream 302 is transmitted to transformation and quantization logic 304 for further processing, as this current block is not dependent upon any other picture.

For the inter-picture predictive mode, motion estimator 310 receives input video bitstream 302 and selects a reference picture 338 from previous picture memory buffer 314. Motion estimator 310 may determine a motion vector (e.g., motion vector between a current block and a block from reference picture 338). Motion estimator 310 may transmit the motion vector as motion vector 336 to motion compensation logic 312 and to entropy encoder 308. Furthermore, motion estimator 310 may transmit motion data (e.g., reference picture 338 and motion vector 336) to control logic 306. Motion compensation logic 312 receives motion vector 336 from motion estimator 310 and a reference block 344 from previous picture memory buffer 314. Motion compensation logic 312 may generate an inter-picture prediction 334 by applying motion compensation to reference block 344 using motion vector 336. Subtractor 348 receives inter-picture prediction 334 and the current block from input video bitstream 302. Subtractor 348 may subtract inter-picture prediction 334 from the current block. Subtractor 348 outputs residual signal 320.

In the transformation and quantization stage, transformation and quantization logic 304 may transforms (e.g., using DCT) residual signal 320 from the spatial domain to the frequency domain. Because the human visual system is more sensitive to low frequency than high frequency images, transformation and quantization logic 304 may also apply quantization such that more low frequency information is retained while high frequency information is discarded.

In the entropy encoding stage, entropy encoder 308 converts syntax elements (quantized coefficients 322 and other information such as motion vectors, prediction modes, etc.) to bitstream to improve compression. Examples of entropy coding methods that may be used by entropy encoder 308 include variable length coding (VLC), which encodes syntax element symbols to an integer number of bits using a lookup Huffman table, and arithmetic coding, which encodes a symbol by its appearance probability and can thus represent a symbol with fractional number of bits thereby achieving higher compression efficiency. Coded video bitstream 318 therefore includes both syntax elements as well as picture data from input video bitstream 302. After the entropy encoding stage, coded video bitstream 318 is ready for transmission or storage.

To ensure that an identical prediction is generated for subsequent pictures in both video encoder 300 and the corresponding decoder, video encoder 300 duplicates the decoder processing loop with inverse transformation and quantization logic 316 and previous picture memory buffer 314. Inverse transformation and quantization logic 316 performs dequantization and inverse transformation of quantized coefficients 322 output by transformation and quantization logic 304 to duplicate a decoded approximation of the residual signal 324. Adder 350 may add decoded approximation of the residual signal 324 and inter-picture prediction 33, the result of which may be filtered to smooth out artifacts induced by block-wise processing and quantization to obtain a final picture representation 340. In intra-picture prediction mode, when no prediction information is needed, initial signal 332 (e.g., 0) may be used instead. In an embodiment, bit length reducer 346 may be present to reduce the precision of final picture representation 340 to generate a reduced final picture representation 342. Previous picture memory buffer 314 may store a decoded video bitstream (which is a duplicate of the output of the decoder corresponding to encoder 300) for the prediction of subsequent pictures. The decoded video bitstream may include final picture representation 340 (at full precision) or reduced final picture representation 342 (at reduced precision). As described above, bit length reducer 346 may be present in video encoder 300 in an embodiment, and when present, may generate reduced final picture representation 342. Additional detail and example embodiments of bit length reducer 346 are described in the next section further below.

The order of encoding or decoding processing of pictures may differ from the order in which they arrive from the source, which requires a distinction between decoding order (i.e., bitstream order) and the output order (i.e., display order) for a decoder. For example, as shown in FIG. 2, the decoding order of the sequence of pictures is 1, 4, 2, 3, 7, 5, 6 based on the interdependencies of the pictures. In contrast, the output order from the decoder for the sequence of picture is 1, 2, 3, 4, 5, 6, 7 based on how the pictures should be displayed.

FIG. 4 shows a block diagram of video decoder 104 that performs video decompression or decoding. Video decoder 104 may include an inverse transformation and quantization logic 404, an entropy decoder 406, a motion compensation logic 408, a previous picture memory buffer 410, and an adder 432. Furthermore, in an embodiment, video decoder 104 may include a bit length reducer 434. Each of the components of video decoder 400 may be implemented as a combination of hardware with software and/or with firmware (e.g., an electronic circuit, an application processor, a digital signal processor, a computer program that executes in one or more processors, etc.). The decoder processing loop for video decoder 104 is essentially identical to the decoder processing loop described above for video encoder 300, thus it will be briefly described below for the sake of brevity. Video decoder 104 of FIG. 4 is shown for purposes of illustration, and is not intended to be limiting, as other types of video decoders are applicable to embodiments. Video decoder 104 is described as follows.

As shown in FIG. 4, entropy decoder 406 receives coded video bitstream 402, which is an example of coded video bitstream 318 of FIG. 3. Entropy decoder 406 converts coded video bitstream 402 into quantized coefficients 414 and syntax element symbols that include side information 420 and motion vector(s) 426. Inverse transformation and quantization logic 404 performs dequantization and inverse transformation of quantized coefficients 414 output by entropy decoder 406 to generate a decoded approximation of the residual signal 416. Motion compensation logic 408 obtains a previous picture 430 from previous picture memory buffer 410 if one is needed. The first picture in coded video bitstream 402 may be an intra-picture that does not depend on any other previous picture in the intra-picture predictive coding mode. In this case, an initial signal 422 (e.g., 0) may be used. For the inter-picture predictive coding mode, motion compensation logic 408 extracts pixel data from previous picture 430 and shifts it by some pixels (e.g., integer shift or fractional shift) via a filter operation to generate a prediction 424 of a current block or current picture. Adder 342 may add residual signal 416 to prediction 424, the result of which may be filtered to smooth out artifacts induced by block-wise processing and quantization to obtain a final picture representation, which forms a part of decoded video bitstream 412 that may be stored or transmitted (e.g., to a display). In an embodiment, bit length reducer 434 may be present to reduce the precision of the final picture representation (decoded video bitstream 412) prior to storage. Previous picture memory buffer 410 stores the final picture representation, in full or reduced precision, as a decoded video bitstream 418 for the prediction of subsequent pictures. Additional detail and example embodiments of bit length reducer 434 are described in the next section.

In transmitting or storing decoded video bitstream 412, it is possible to reduce data stream bandwidth and/or storage by selectively transmitting or storing lower precision pictures that will not be used in subsequent predictions and only used for display. For instance, bit length reducer 112 of FIG. 1 may be present in video decoder 104 of FIG. 4 (e.g., as bit length reducer 434) to reduce a precision of pixels in pictures of the data stream, and thereby reduce bandwidth, storage requirements, etc. Embodiments provide the benefits of improved efficiency in the video encoding or decoding process by allowing a reduction of memory, power and/or bandwidth. For example, in decoding 10-bits of precision coded content, DRAM power and bandwidth may be saved by twenty percent compared to conventional video encoding and decoding techniques. Example embodiments for data stream precision reduction are described in the following section.

### 4. Example Embodiments for Data Stream Precision Reduction

The example embodiments described herein are provided for illustrative purposes and are not limiting. The examples described herein may be adapted to any type of mobile or stationary devices. Furthermore, additional structural and operational embodiments, including modifications will become apparent to persons skilled in the relevant art(s) from the teachings herein.

In example embodiments, methods, systems, and apparatuses for selectively reducing a precision of a picture are provided. A video bitstream that includes a plurality of pictures is received at a decoder. A relative importance of a current picture regarding future predictions of subsequent pictures of the plurality of pictures is determined, where each pixel of the current picture includes a first pixel component having a first bit length (and may include further pixel components having similar bit lengths). Whether to reduce a precision of the current picture based on the determined relative importance of the current picture is determined A precision of the current picture is selectively reduced to create a reduced precision picture, where each pixel of the reduced precision picture includes a second pixel component having a second bit length that is less than the first bit length.

In example embodiments, a bit length reducer is provided that receives a plurality of pictures including one or more full precision pictures. The bit length reducer determines a relative importance of each of the plurality of pictures regarding future predictions of subsequent pictures. Based on the determined relative importance, the bit length reducer can selectively generate one or more reduced precision pictures to transmit or store, thereby reducing memory usage, power consumption, and/or data transmission bandwidth. The bit length reducer described herein relates to video encoders and decoders and the video coding process. However, the bit length reducer may be implemented as being partially or fully integrated into the video encoders or decoders or the bit length reducer may be implemented as a standalone component or as part of another device separate from the video encoders and decoders.

Techniques described herein relate to video decoder and video decoding. However, these techniques are also applicable to the video encoder and video encoding because the video encoder duplicates the video decoder processing loop such that both will generate identical predictions for subsequent pictures in the video bitstream.

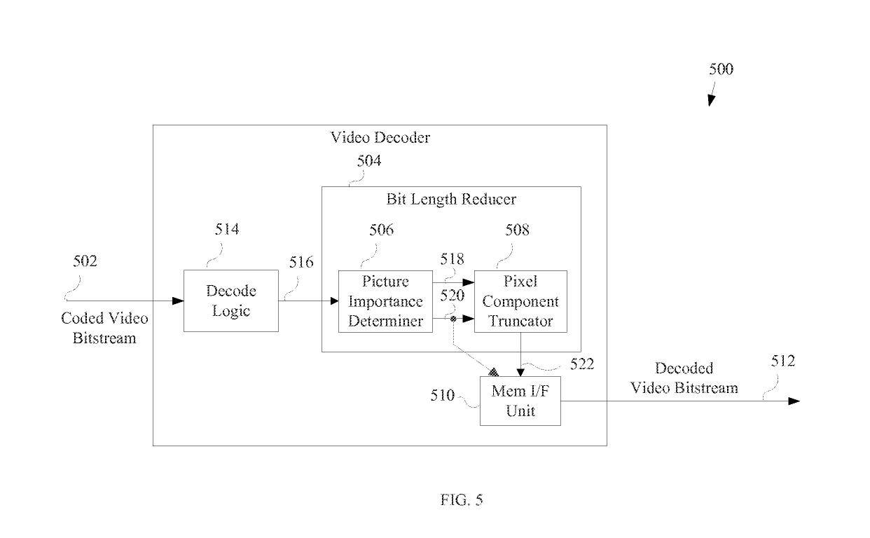

FIG. 5 shows a block diagram of a video decoder 500 according to an example embodiment. As shown in FIG. 5, video decoder 500 includes decode logic 514, a bit length reducer 504, and a memory interface (I/F) unit 508. As shown in FIG. 5, bit length reducer 504 includes a picture importance determiner 506 and a pixel component truncator 508. Each of the components of video decoder 500 may be implemented as a combination of hardware with software and/or with firmware (e.g., an electronic circuit, an application processor, a digital signal processor, a computer program that executes in one or more processors, etc.). Video decoder 500 is described as follows.

As shown in FIG. 5, decode logic 514 receives coded video bitstream 502. Coded video bitstream 502 includes a plurality of pictures received from a source, such as a main memory storage, a cable demodulator, an Internet interface module, a network interface module, a buffer, or any other data storage or source. Coded video bitstream 502 may be received over a wired (e.g., Ethernet, cable) or wireless (e.g., Wi-Fi®) medium. Decode logic 514 is configured to decode coded video bitstream 502, which is an encoded video data stream similar to coded video bitstream 110 of FIG. 1 and coded video bitstream 402 of FIG. 4. As shown in FIG. 5, decode logic 514 generates decoded video bitstream 516, which is an example of decoded video bitstream 412 shown in FIG. 4 or other decoded video bitstream, and includes a sequence of decoded or reconstructed pictures. Decoded video bitstream 412 may be represented as any number of bits of precision per luma and chroma component (e.g., Y, Cb, Cr), such as in 8 bits or 10 bits of precision per pixel component, for example. Thus, each pixel component includes a bit length, which may be any size (e.g., 8 bits or 10 bits). In other embodiments, other types of video data (e.g., red-green-blue (RGB) data, etc.) and/or component bit lengths may be used. Decode logic 514 may be implemented in any manner to decode coded video bitstream 502, such as being implemented similarly to video decoder 104 of FIG. 4, or being implemented in any other manner.

As shown in FIG. 5, bit length reducer 504 receives decoded video bitstream 516. Bit length reducer 504 is an example of bit length reducer 112 of FIG. 1 or bit length reducer 346 of FIG. 3, and is configured to reduce a precision of some pictures received in coded video bitstream 502 by operating on decoded video bitstream 516. Furthermore, in an embodiment, bit length reducer 434 of FIG. 4 may be implemented similarly to bit length reducer 504. In an embodiment, bit length reducer 504 may include picture importance determiner 506 and pixel component truncator 508, which cooperate collaboratively to reduce the bit length of one or more pixel component of a current picture in decoded video bitstream 516 by one or more bits. For example, the bit length of a pixel component may be reduced from 10 bits to 8 bits or 10 bits to 6 bits.

For instance, picture importance determiner 506 may receive decoded video bitstream 516 and determine a relative importance of each picture in decoded video bitstream 516 with regard to future predictions of subsequent pictures. A picture of a received stream of pictures that is currently being processed may be called a “current picture.” At video decoder 500, it is known whether a picture will be used in a future or subsequent prediction, based on the type of picture (e.g., intra-picture, inter-picture, etc.) and the format of the video stream (e.g., MPEG-4 standard or H.265, etc.). Thus, for each picture of a received picture stream, picture importance determiner 506 generates a reducibility indicator 518, and provides the generated reducibility indicator 518 and corresponding picture data 520 of the picture to pixel component truncation 508. For each picture that is determined to not be used for future predictions, picture importance determiner 506 generates reducibility indicator 518 in a manner that flags or indicates the picture as being reducible. For each picture that is determined to not be used in future predictions, the number of predictions that the picture may subsequently be used in may or may not be known. In any event, for each picture that is determined to not be used in future predictions, picture importance determiner 506 generates reducibility indicator 518 to indicate a relative importance of the picture (e.g., by an increasing integer value that indicates increasing importance/predictions, on a scale of 0.0 to 1.0 where 0.0 indicates the picture not likely to be used in any predictions and 1.0 indicates the picture as likely to be used in many predictions, or in another manner).

Such information regarding how many predictions a picture may be used—the relative importance of a picture—may be determined or estimated by picture importance determiner 506 through a heuristic procedure to determine the role of the picture in a hierarchy of pictures. For example, the relative importance of a picture may be estimated/determined by picture importance determiner 506 based on its position in its group-of-pictures structure, based on the type of picture (e.g., B-frame, P-frame, etc.), and/or the format of the video stream.

The relative importance of a picture is important because if there are relatively few future predictions made based on a picture, there is relatively little harm in reducing the precision of that picture to save power and/or bandwidth. For example, if a current or given picture is used once in a prediction operation, storing that picture with a reduced precision may have little downside, while power and bandwidth may be saved. In a particular example, a 10 bit precision picture may be transmitted/stored as an 8 bit precision picture, which is sufficient for most displaying purposes. Sometimes, it is possible to avoid storing full precision pictures if it can be determined that those pictures may be used for none or a small number of subsequent predictions because the drift, an occurrence where the decoder is not fully compliant with the model of the decoder that is used in the encoder, is tolerable if the number of subsequent predictions are limited (e.g., one or two cascaded predictions where a given picture directly or indirectly impacts more than one subsequent predictions). On the contrary, if a given picture will be used for many subsequent predictions, it may be more beneficial for to store that picture with full precision and no reduction. Thus, the relative importance of a picture may be used to determine whether to transmit and/or store that picture with a reduced precision.

Picture importance determiner 506 determines the relative importance of a picture by using any amount of data, and based on any number of factors such as the particular video coding standard being used. For example, picture importance determiner 506 may determine the relative importance of a picture based on a temporal identifier, which indicates where a picture fits in a temporal hierarchy. For instance, a picture with a higher temporal identifier may be used less frequently in subsequent predictions.

In another example, picture importance determiner 506 may determine the relative importance of a picture based on a position of the picture in a group-of-picture structure in which the picture is included. Coded video bitstream 502 may conform to a common group-of-picture structure, where a picture in a particular position of the structure typically is known to be involved in zero, one, two, or further known numbers of predictions. Accordingly, an importance estimation may be made for the picture based on its position in that group-of-picture structure. For example, video decoder 500 may receive a new intra-picture every 15 pictures that is coded directly without regard to any reference picture. In such case, picture importance determiner 506 may estimate how close a received picture is to the intra-picture location in the 15 picture stream in order to determine whether the given picture has many or few subsequent predictions.

In a specific example, picture importance determiner 506 may determine the relative importance of a picture by determining that the encoder is using a conventional group-of-picture structure, such as the IPBB format shown in FIG. 2 where the B-frame is never used for subsequent predictions, the P-frame is used for subsequent prediction up to the next I-frame. Thus, picture importance determiner 506 may determine how many P-frames are sent in between I-frames to determine a position of a particular picture in the IPBB group-of-picture structure to determine the picture's importance.

Picture importance determiner 506 may use further data and/or techniques to determine or estimate the relative importance of a picture. For example, picture importance determiner 506 may discern information by processing a network abstraction layer (NAL) unit which contains syntax structure (e.g., a video parameter set, a sequence parameter set, a picture parameter set, etc.) and can indicate the purpose of the associated video payload data. Picture importance determiner 506 may also discern useful information regarding relative importance from the picture type (e.g., reference picture or predictive picture). Moreover, picture importance determiner 506 may scan ahead through coded video bitstream 502 to view header information and discern hierarchy information for the picture to aid in determining picture importance.

As shown in FIG. 5, pixel component truncator 508 receives reducibility indicator 518 and corresponding picture data 520 for each picture in the stream of pictures in the video data stream. Pixel component truncator 508 selectively performs a truncation operation on picture data 520 for the current picture based on its determined relative importance indicated by reducibility indicator 518. For instance, pixel component truncator 508 may remove 1, 2, 3, or even a greater number of right-most bits from one or more pixel components of one or more pixels of a picture pixel array to create a reduced precision picture 522. Reduced precision picture 522 includes pixel data 520 for the current picture, modified with at least one reduced pixel component. For example, a full precision picture may include an array of pixels that each include a luma, Cb, and Cr pixel component. Each of the luma, Cb, and Cr pixel components may include 10 bits of data. If reducibility indicator 518 indicates that the picture importance is low enough for truncation, pixel component truncator 508 may reduce a bit length of one or more of the luma, Cb, and/or Cr pixel components for each pixel of the picture from 10 bits to fewer bits (e.g., 8 bits).

Thus, pixel component truncator 508 selectively performs the truncation operation on pictures that have been flagged as being reducible or pictures having relatively low importance. Pictures that have relatively high importance are not truncated. The logic used by pixel component truncator 508 to determine which pictures to truncate may be configurable, based on the application of video decoder 500, based on design constraints, based on a mode selection (e.g., a high fidelity mode or a low power mode), etc.

For example, in an embodiment, pixel component truncator 508 may determine the number of future predictions to be made from a current picture and compare the determined number to a predetermined threshold value. If the number of future predictions is zero (lowest importance), pixel component truncator 508 may reduce the precision of that picture. If the number of future predictions is greater than zero but less than the threshold value, pixel component truncator 508 may reduce the precision of that picture. Pixel component truncator 508 may use additional or alternative information (e.g., past history) to help determine whether to reduce the picture precision. If the number of future predictions is equal to the threshold value or greater, then pixel component truncator 508 may not reduce the precision of the picture.

In an example embodiment, the threshold value may be set at a very large number, including infinity, such that all pictures are reduced in precision. In another example embodiment, the threshold value may be set to 0 such that the truncation operation is effectively disabled. Thus, the truncation operation is configurable according to any number of parameters that may be set automatically or manually depending on the application and desired goals.

Pixel component truncator 508 can selectively perform the truncation operation in any other manner, with or without using a threshold value. For example, pixel component truncator 508 may selectively perform the truncation operation based on one or more ranges of relative importance of a picture or group of pictures and/or some other information (e.g., a mode of operation such as high fidelity or low power). In an example embodiment, pixel component truncator 508 may perform the truncation operation on pictures when it is determined that those pictures are not to be used in many cascaded predictions. In another embodiment, pixel component truncator 508 may perform the truncation operation on a group of pictures, even if all of the pictures of the group may be used in numerous cascaded predictions. For instance, a subset of pictures of the group may be reduced in precision, which may result in relatively little drift between the reconstructed pictures in the encoder and decoder.

As shown in FIG. 5, memory interface unit 510 receives reduced precision picture 522 for one or more pictures in the received video data stream that were reduced in precision by pixel component truncator 508. Memory interface unit 510 may receive picture data 520 for full precision pictures that were not reduced in precision by pixel component truncator 508. Memory interface unit 510 outputs decoded video bitstream 512, which includes any full precision pictures and any reduced precision pictures received from bit length reducer 504, and therefore contains all of the pictures received in decoded video bitstream 516, one or more of which are pictures reduced in precision as described above. Memory interface unit 510 supports access to at least one memory storage and/or other peripherals. For example, memory interface unit 510 may connect a system-on-chip (SOC) in which bit length reducer 504 and/or decode logic 514 reside to an external memory or other storage device, and/or other peripheral device.

As such, memory space is conserved in embodiments. For instance, prior to reducing precision, if 10 bits of precision per pixel component is stored for a YCbCr pixel, a total of 30 bits for the three YCbCr components may be mapped to 4 bytes of storage, which equals 32 bits where two bits are wasted. In contrast, if 8 bits of precision per pixel component is stored for a YCbCr pixel, a total or 24 bits for the three components may be mapped to 3 bytes of storage. Thus, by reducing the number of bits by 2 per component a total of 6 bits may be saved, which results in a 20% storage space reduction.

Note that pixel component truncator 508 may perform the truncation operation selectively across the pixel components of a picture pixel. In other words, the truncation operation does not have to be applied uniformly across the three pixel components (YCbCr). For example, in an embodiment, only the chroma components (Cb, Cr) are reduced in bit length while the luma component remains at full bit length or the luma component is reduced along with the Cb component but not the Cr component. Other combinations for reducing the components may also be performed.

Pictures in decoded video bitstream 512 may be stored in a previous picture memory buffer, such as previous picture memory buffer 410 of FIG. 4 to be used in subsequent predictions. To be used in subsequent predictions, any reduced precision picture may need to be reconstructed to be a full precision picture. This reconstruction may be performed by a pixel component reconstructor (not shown in FIG. 5) to invert the truncation operation performed by pixel component truncator 508. For example, the pixel component reconstructor may add a binary value as the right most bits to each of the reduced pixel component to create a full precision pixel component. For instance, a binary value of 2 (binary 10) or other selected binary value may be added as the right most bits to a reduced pixel component bit length of 8 bits to obtain a full pixel component bit length of 10 bits

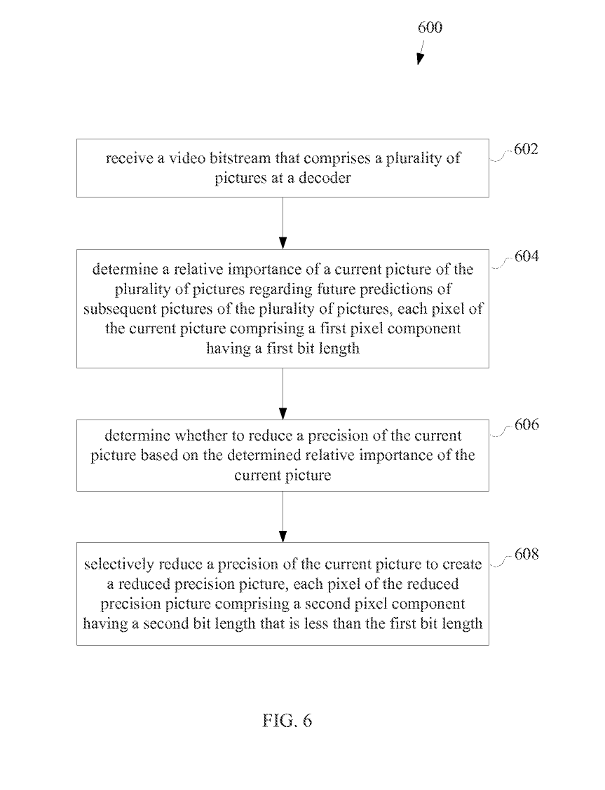

Accordingly, a picture may be reduced in precision to save memory, power, and/or bandwidth in a variety of ways according to embodiments. For instance, FIG. 6 shows a flowchart 600 providing a process for selectively reducing a precision of a picture according to an example embodiment. Flowchart 600 may be performed by video decoder 500 shown in FIG. 5 for example. Flowchart 600 may also be performed by other devices and/or systems in other embodiments. Further structural and operational embodiments will be apparent to persons skilled in the relevant art(s) based on the discussion regarding flowchart 600. Flowchart 600 is described as follows.

Flowchart 600 begins with step 602. In step 602, a video bitstream that comprises a plurality of pictures is received at a decoder. For instance, as shown in FIG. 5, coded video bitstream 502 is received at video decoder 500. Coded video bitstream 502 may be received from a source such as a main memory storage, a cable demodulator, an Internet interface module, a network interface module, a buffer, or any other data storage area via a wired (e.g., Ethernet, cable) or wireless (e.g., Wi-Fi®) medium.

In step 604, a relative importance of a current picture of the plurality of pictures regarding future predictions of subsequent pictures of the plurality of pictures is determined, each pixel of the current picture comprising a first pixel component having a first bit length. For instance, as shown in FIG. 5, decode logic 514 may decode coded video bitstream 502 to decoded video bitstream 516, which includes a stream of pictures. Picture importance determiner 506 may determine a relative importance of a current picture in a variety of ways (e.g., temporal ID, GOP structure, picture type, NAL unit, scanning ahead) as described above. Picture importance determiner 506 may generate reducibility indication 518 to indicate a relative importance of a picture defined by picture data 520.

In step 606, a decision whether to reduce a precision of the current picture based on the determined relative importance of the current picture is determined. For instance, as shown in FIG. 5, pixel component truncator 508 may determine whether to reduce a precision of the current picture based on the relative importance of the current picture indicated by reducibility indication 518. As described above, pixel component truncator 508 may make such a determination based on a configurable threshold value, for example, or in another manner. For instance, pixel component truncator 508 may compare the determined relative importance of the current picture to the threshold value. If the current picture has a relatively low importance compared to the threshold value (i.e., the relative importance of the picture is lower than the threshold value), the current picture may be reduced in precision. If the current picture has a relatively high importance compared to the threshold value (i.e., the relative importance of the picture is higher than the threshold value), the current picture may not be reduced and may be transmitted/stored as a full precision picture.

In step 608, a precision of the current picture is selectively reduced to create a reduced precision picture, each pixel of the reduced precision picture comprising a second pixel component having a second bit length that is less than the first bit length. For example, as shown in FIG. 5 a precision of the current picture may be selectively reduced by pixel component truncator 508 and/or memory interface unit 510. The reduction is selective because it is performed based on the relative importance of the current picture, thus not all pictures in coded video bitstream 502 may be reduced. In addition, the reduction may be selective relative to the pixel components of the current pictures. For example, for a YCbCr format picture, one or more of the YCbCr pixel components may be reduced for the current picture. Thus, a picture having pixel components that are 10 bits long each at full precision may be reduced such that one or more of the three YCbCr pixel components are reduced to 8 bits. It is noted that the bit lengths mentioned herein are illustrative and not meant to be limiting.

The process of step 608 may be inverted to reconstruct one or more full precision pictures based on the reduced precision picture. This may be performed if the reduced precision picture is to be used for a future prediction in the video decoding process. The reconstruction of a full precision picture from a reduced precision picture may be performed by a pixel component reconstructor to add a binary value as the right most bits (concatenate) to each of the reduced pixel components to create full precision pixel components. For instance, a binary value of 2 (binary 10) or other binary value may be added as the right most bits to a reduced pixel component bit length of 8 bits to obtain a full pixel component bit length of 10 bits.

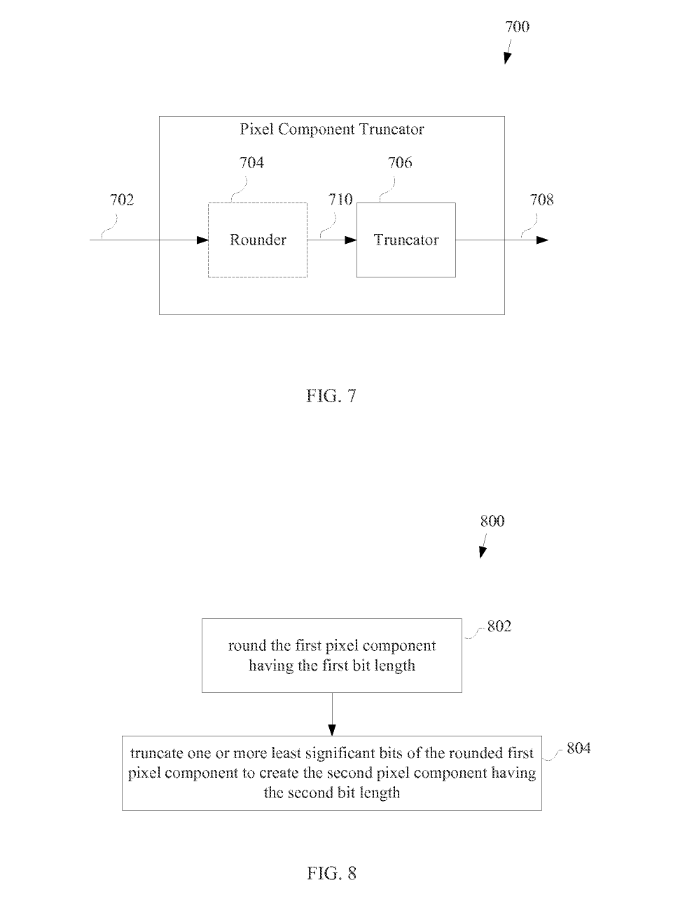

Pixel component truncator 508 may be configured in various ways in embodiments. For instance, FIG. 7 shows a block diagram of a pixel component truncator 700 according to an example embodiment. Pixel component truncator 700 may be an example of pixel component truncator 508. Pixel component truncator 700 includes a rounder 704 and a truncator 706. Each of these components may be implemented in hardware or a combination of hardware with software and/or with firmware (e.g., an electronic circuit, an application processor, a digital signal processor, a computer program that executes in one or more processors, etc.). Pixel component truncator 700 is described as follows.

Rounder 704 receives a signal 702 that includes a decoded or reconstructed video bitstream (e.g., picture data 520 of FIG. 5) and relative importance information (e.g., reducibility indication 518 of FIG. 5) for each picture in the decoded video bitstream. For each pixel component of a picture that is to be reduced, rounder 704 performs a rounding operation by adding or subtracting a fixed value to the bit length of that pixel component. For example, for a pixel component having a 10-bit bit length, rounder 704 may add a binary value of 2 to remove the two least significant (right most) bits. Accordingly, rounder 704 generates rounded picture data 710 for each received picture of the video bitstream that is being reduced in precision.

Truncator 706 receives rounded picture data 710 from rounder 704. Truncator 706 performs a truncation operation on rounded picture data 710 based on the relative importance of the picture. In performing the truncation operation on a rounded picture data picture, truncator 706 may simply discard a specified/desired number of least significant bits from one or more pixel component bit lengths. For example, truncator 706 may discard the two least significant bits to reduce a 10-bit of precision picture to an 8-bit of precision picture. Truncator 706 generates an output 708 (e.g., reduced precision picture 522 of FIG. 5) which includes a reduced precision picture for rounded picture data 710.

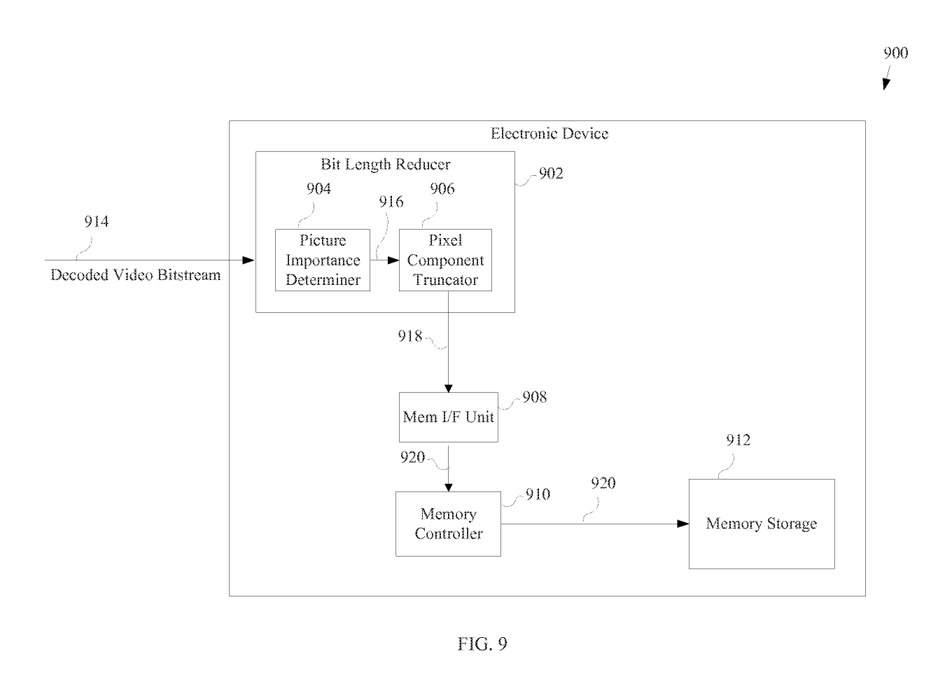

The truncation operation may be performed in a variety of ways according to embodiments. For instance, FIG. 8 shows a flowchart 800 providing a process for truncating one or more pixel components of a picture according to an embodiment. Flowchart 800 may be performed by pixel component truncator 508 shown in FIG. 5, or pixel component truncator 700 shown in FIG. 7, for example. Flowchart 800 is described as follows.

Flowchart 800 begins with step 802. In step 802, the first pixel component having the first bit length is rounded. For instance, as shown in FIG. 7, rounder 704 performs a rounding operation on one or more pixel components of a picture that is currently being processed. Each pixel component having a bit length (e.g., 10 bits, 8 bits, 6 bits) may be rounded. Rounder 704 may add or subtract a fixed binary number (e.g., a binary value of 2) to each pixel component bit length to round up or down, respectively. For example, for a pixel component having a 10 bit binary value of 1010101010, a binary value of 10 may be added, to generate a rounded pixel component binary value of 1010101100.

In step 804, one or more least significant bits of the rounded first pixel component is/are truncated to create the second pixel component having the second bit length. For instance, as shown in FIG. 7, truncator 706 performs a truncation operation on the rounded picture data 710, which may include rounded pixel component(s), received from rounder 704. Each rounded pixel component having a bit length (e.g., 10 bits, 8 bits, or 6 bits) may be selectively truncated. Truncator 706 may discard one or more least significant bits of the bit length of each rounded pixel component resulting in a reduced bit length for each rounded pixel component. For example, rounded pixel component binary value of 1010101100 may be reduced from 10 bits to 8 bits by truncating the right most bits of 00, resulting in a reduced precision pixel component of 10101011.

Embodiments may be implemented in a variety of electronic devices mentioned elsewhere herein or otherwise known. For instance, FIG. 9 shows a block diagram of an electronic device 900 that includes a bit length reducer 902 for reducing a precision of a picture, according to an example embodiment. As shown in FIG. 9, electronic device 900 includes a bit length reducer 902, a memory interface unit 908, a memory controller 910, and memory storage 912. Bit length reducer 902 may further include a picture importance determiner 904 and a pixel component truncator 906. For the sake of brevity, many of these components, functions, and concepts related to electronic device 900 may be briefly described or not described as follows because these components, functions, and related concepts have been described elsewhere herein with reference to video decoder 500 of FIG. 5, pixel component truncator 700 of FIG. 7, flowchart 600 of FIG. 6, and/or flowchart 800 of FIG. 8.

In an embodiment, decoded video bitstream 914 is received at bit length reducer 904. Decoded video bitstream 914 may be received from a video decoder (e.g., video decoder 500 of FIG. 5) or decode logic (e.g., decode logic 514 of FIG. 5) which may have decoded a coded video bitstream that includes a plurality of full precision pictures to form decoded video bitstream 914. Bit length reducer 902 may be generally similar to bit length reducer 504 of FIG. 5 in composition and functionality. Picture importance determiner 904 determines a relative importance of each picture regarding future predictions of subsequent pictures in the decoded video bitstream. For each picture, picture importance determiner 904 provides the picture data along with a reducibility indication 916 to pixel component truncator 906 to indicate whether the picture is reducible. Pixel component truncator 906 selectively performs a truncation operation on the pictures that have been flagged with the reducible indicator or pictures having relatively low importance and generates a stream of pictures 918 that includes full and/or reduced precision pictures.

Memory interface unit 910 maps stream of pictures 918 to respective address locations in memory storage 912. In other words, memory interface unit 910 supports access to memory storage 912 and/or other memory or peripherals. For example, memory interface unit 910 may connect a system-on-chip (SOC) on which bit length reducer 902 resides to an external memory or other peripherals. Such an external memory may be memory storage 912 or some other memory storage not included in electronic device 900. Memory interface unit 908 receives stream of pictures 918 from pixel component truncator 906 and dictates where and/or how stream of pictures 918 are stored/transmitted. In an example embodiment, pixel component truncator 906 makes the decision whether to truncate a picture, but sends the full precision picture to memory interface unit 908, which maps a reduced precision picture rather than the full precision picture to a memory storage, effectively reducing the precision of the picture. As a more specific example, memory interface unit 908 may map a reduced 8 bits of precision per component instead of 10 bits to memory and ignore and/or discard the remaining 2 bits. Memory interface unit 908 may transmit address locations along with stream of pictures 918 as addressed pictures 920 to memory controller 910.

Memory controller 910 controls the storage of addressed pictures 920. Memory controller 910 is a circuit that manages the flow of data going to and from memory storage 912. Memory controller 910 may contain logic to facilitate reads and writes to memory storage 912 as well as refresh memory storage 912 to prevent data loss. Thus, memory controller 910 may control the storage of address pictures 920.

Memory storage 912 stores one or more full and/or reduced precision pictures. For example, memory storage 912 may store addressed pictures 920. Memory storage 912 may be a main memory for data, such as the decoded video bitstream. Memory storage 912 may also serve as the storage area for coded video to be decoded or any other data needed for video processing. Memory storage 912 may be physical storage device, such as a memory device (e.g., static random access memory (SRAM), dynamic random access memory (DRAM), etc.), a hard disc drive, optical storage, or a virtual storage location.

### 5. Example Computer Embodiments

Video decoder 104, memory controller 106, bit length reducer 112, transformation and quantization logic 304, control logic 306, entropy encoder 308, motion estimator 310, motion compensation logic 312, previous picture memory buffer 314, inverse transformation and quantization logic 316, bit length reducer 346, inverse transformation and quantization logic 404, entropy decoder 406, motion compensation logic 408, bit length reducer 434, video decoder 500, bit length reducer 504, picture importance determiner 506, pixel component truncator 508, memory interface unit 510, decode logic 514, pixel component truncator 700, rounder 704, truncator 708, electronic device 900, bit length reducer 902, picture importance determiner 904, pixel component truncator 906, memory interface unit 908, memory controller 910, memory storage 912, flowchart 600, flowchart 800 (including any one or more steps of flowcharts 600 and 800) and/or any further systems, sub-systems, and/or components disclosed herein may be implemented in hardware (e.g., hardware logic/electrical circuitry), or any combination of hardware with software (computer program code configured to be executed in one or more processors or processing devices) and/or with firmware.

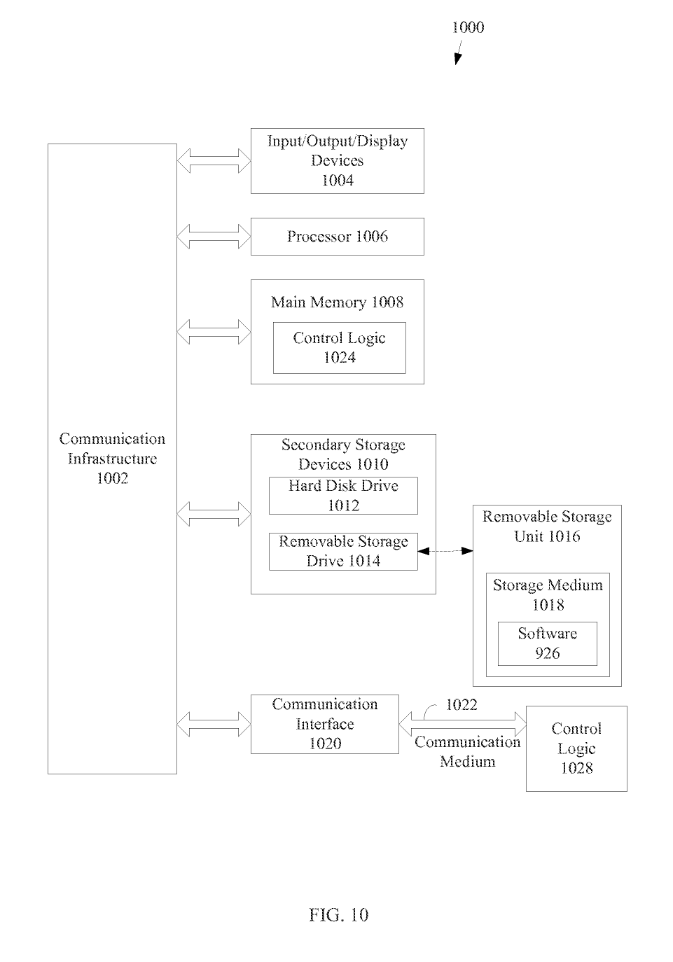

The embodiments described herein, including systems, methods/processes, and/or apparatuses, may be implemented using well-known processing devices, telephones (smart phones and/or mobile phones), set-top boxes, game consoles, audio/video receivers, servers, and/or computers (e.g., tablet, netbook, desktop, laptop, etc.), such as computer 1000 shown in FIG. 10. It should be noted that computer 1000 may represent communication devices, processing devices, and/or traditional computers in one or more embodiments. For example, video decoder 104, video decoder 500, electronic device 900 and any of the sub-systems or components respectively contained therein may be implemented using one or more computers 1000, including all or a portion of the features described for computer 1000 as follows.

Computer 1000 can be any commercially available and well-known communication device, processing device, and/or computer capable of performing the functions described herein, such as devices/computers available from International Business Machines®, Apple®, Sun®, HP®, Dell®, Cray®, Samsung®, Nokia®, etc. Computer 1000 may be any type of computer, including a desktop computer, a mobile device (e.g., a smart phone, a laptop, a netbook, a tablet computer, etc.), a server, etc.

Computer 1000 includes one or more processors (also called central processing units or CPUs), such as processor 1006. Processor 1006 is connected to a communication infrastructure 1002, such as a communication bus. In some embodiments, processor 1006 can simultaneously operate multiple computing threads.

Computer 1000 also includes a primary or main memory 1008, such as random access memory (RAM). Main memory 1008 has stored therein control logic 1024 (computer software), and data.

Computer 1000 also includes one or more secondary storage devices 1010, including, for example, a hard disk drive 1012 and/or a removable storage device or drive 1014. Computer 1000 may also include other types of storage devices, such as memory cards and memory sticks. For instance, computer 1000 may include an industry standard interface, such as a universal bus (USB) interface for interfacing with devices such as a memory stick. Removable storage drive 1014 represents a floppy disk drive, a magnetic tape drive, a compact disk drive, an optical storage device, tape backup, etc.

Removable storage drive 1016 interacts with a removable storage unit 1016. Removable storage unit 1016 includes a computer useable or readable storage medium 1018 having stored therein computer software 1026 (control logic) and/or data. Removable storage unit 1016 represents a floppy disk, magnetic tape, compact disk, DVD, optical storage disk, or any other computer data storage device. Removable storage drive 1014 reads from and/or writes to removable storage unit 1016 in a well-known manner.

Computer 1000 also includes input/output/display devices 1004, such as touchscreens, LED and LCD displays, monitors, keyboards, pointing devices, etc.

Computer 1000 further includes a communication or network interface 1020. Communication interface 1020 enables computer 1000 to communicate with remote devices. For example, communication interface 1020 allows computer 1000 to communicate over communication networks or medium 1022 (representing a form of a computer usable or readable medium), such as LANs, WANs, the Internet, etc. Network interface 1020 may interface with remote sites or networks via wired or wireless connections.

Control logic 1028 may be transmitted to and from computer 1000 via communication medium 1022.

Any apparatus or manufacture comprising a computer usable or readable medium having control logic (software) stored therein is referred to herein as a computer program product or program storage device. This includes, but is not limited to, computer 1000, main memory 1008, secondary storage devices 1010, and removable storage unit 1016. Such computer program products, having control logic stored therein that, when executed by one or more data processing devices to operate as described herein, represent embodiments.

Devices in which embodiments may be implemented may include storage, such as storage devices, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (E.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic to implement, for example, video decoder 104, memory controller 106, bit length reducer 112, transformation and quantization logic 304, control logic 306, entropy encoder 308, motion estimator 310, motion compensation logic 312, previous picture memory buffer 314, inverse transformation and quantization logic 316, bit length reducer 346, inverse transformation and quantization logic 404, entropy decoder 406, motion compensation logic 408, bit length reducer 434, video decoder 500, bit length reducer 504, picture importance determiner 506, pixel component truncator 508, memory interface unit 510, decode logic 514, pixel component truncator 700, rounder 704, truncator 708, electronic device 900, bit length reducer 902, picture importance determiner 904, pixel component truncator 906, memory interface unit 908, memory controller 910, memory storage 912, flowchart 600, flowchart 800 (including any one or more steps of flowcharts 600 and 800) and/or further embodiments described herein. Embodiments are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, radio frequency (RF), infrared and other wireless media. Embodiments are also directed to such communication media.

### B. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A device, comprising:
a video decoder configured to receive a video bitstream comprising a plurality of pictures, the video decoder comprising
a picture importance determiner configured to determine a relative importance of a current picture of the plurality of pictures regarding future predictions of subsequent pictures of the plurality of pictures, the current picture comprising a first pixel component having a first bit length, and
a pixel component truncator configured to selectively perform a truncation operation on the current picture based on the determined relative importance of the current picture to create a reduced precision picture that comprises a second pixel component having a second bit length that is less than the first bit length.

2. The device of claim 1, wherein the picture importance determiner is configured to determine the relative importance of the current picture based on one or more parameters, including a temporal identifier, a group of picture structure, and/or a picture type.

3. The device of claim 1, wherein the pixel component truncator is configured to compare the determined relative importance of the current picture to a threshold; and
wherein the pixel component truncator is configured to perform the truncation operation if the determined relative importance of the current picture is below the threshold.

4. The device of claim 1, wherein the pixel component truncator is configured to selectively perform the truncation operation by truncating one or more least significant bits of the first pixel component having the first bit length to create the second pixel component having the second bit length.

5. The device of claim 1, wherein the pixel component truncator is configured to selectively perform the truncation operation by rounding the first pixel component having the first bit length and truncating one or more least significant bits of the rounded first pixel component to create the second pixel component having the second bit length.

6. The device of claim 1, wherein the video decoder is configured to reconstruct one or more full precision pictures based on the reduced precision picture.

7. The device of claim 6, wherein the video decoder is configured to reconstruct one or more full precision pictures by adding one or more bits to the reduced precision picture to generate the one or more full precision pictures.

8. A method comprising:
receiving a video bitstream that comprises a plurality of pictures at a decoder;
determining a relative importance of a current picture of the plurality of pictures regarding future predictions of subsequent pictures of the plurality of pictures, each pixel of the current picture comprising a first pixel component having a first bit length;
determining whether to reduce a precision of the current picture based on the determined relative importance of the current picture; and
selectively reducing a precision of the current picture to create a reduced precision picture, each pixel of the reduced precision picture comprising a second pixel component having a second bit length that is less than the first bit length.

9. The method of claim 8, wherein said determining the relative importance of the current picture comprises:
determining the relative importance of the current picture based on one or more parameters, including a temporal identifier, a group of picture structure, and/or a picture type.

10. The method of claim 8, wherein said determining whether to reduce a precision of the current picture comprises:
comparing the determined relative importance of the current picture to a threshold; and
wherein said selectively reducing a precision of the current picture comprises:
performing a truncation operation on the first pixel component of each pixel if the determined relative importance of the current picture is below the threshold.

11. The method of claim 8, wherein said selectively reducing a precision of the current picture comprises, for each pixel:
truncating one or more least significant bits of the first pixel component having the first bit length to create the second pixel component having the second bit length.

12. The method of claim 8, wherein said selectively reducing a precision of the current picture comprises, for each pixel:
rounding the first pixel component having the first bit length; and
truncating one or more least significant bits of the rounded first pixel component to create the second pixel component having the second bit length.

13. The method of claim 8, further comprising:
reconstructing one or more full precision pictures based on the reduced precision picture.

14. An electronic device, comprising:
a bit length reducer configured to receive a plurality of pictures having one or more full precision pictures and to selectively generate one or more reduced precision pictures based on at least one picture importance determined for the plurality of pictures, the one or more reduced precision pictures having pixel bit lengths that are less than the pixel bit lengths of the one or more full precision pictures;
a memory controller for controlling storage of the one or more full precision pictures and one or more reduced precision pictures; and
a memory storage for storing the one or more full precision pictures and the one or more reduced precision pictures.

15. The electronic device of claim 14, wherein the bit length reducer comprises:
a picture importance determiner that is configured to determine a relative importance of each of the plurality of pictures regarding future predictions of subsequent pictures of the plurality of pictures; and
a pixel component truncator configured to selectively perform a truncation operation on pixels of the plurality of pictures based on the determined relative importance.

16. The electronic device of claim 15, further comprising a memory interface unit that is configured to map the one or more full precision pictures and the one or more reduced precision pictures to respective address locations of the memory storage.

17. The electronic device of claim 15, wherein the picture importance determiner is configured to determine the relative importance of each of the plurality of pictures based on one or more parameters, including a temporal identifier, a group of picture structures, and/or a picture type.

18. The electronic device of claim 15, wherein the pixel component truncator is configured to determine whether to truncate the pixels of the plurality of pictures by comparing the determined relative importance of each of the plurality of pictures to a threshold; and
wherein the pixel component truncator is configured to selectively perform the truncation operation when the determined relative importance is below the threshold.

19. The electronic device of claim 15, wherein the pixel component truncator is configured to selectively perform the truncation operation after a rounding operation is performed by the pixel component truncator on pixels of the plurality of pictures.

20. The electronic device of claim 15, wherein for a picture subgroup that contains a series of pictures that are all used for future predictions, the pixel component truncator is configured to perform the truncation operation on pixels of at least one but not all pictures of the picture subgroup.
